(19) United States
(12) Patent Application Publication
(10) Pub. No.: US 2007/0277705 A1
(43) Pub. Date: Dec. 6, 2007

(54) CARBONIZED SHAPED POLYMERIC FOAM EMI SHIELDING ENCLOSURES

(75) Inventor: Rick Lucas, St. Clairsville, OH (US)

Correspondence Address: PHILIP D. LANE, P.O. BOX 79318, CHARLOTTE, NC, 28271-7063, US

(73) Assignee: TOUCHSTONE RESEARCH LABORATORY, LTD., Triadelphia, WV (US)

(21) Appl. No.: 11/421,862

(22) Filed: Jun. 2, 2006

(51) Int. Cl. C09C 1/44

(52) U.S. Cl. 106/472

(57) ABSTRACT

Carbon foam enclosures for at least partially or mostly shielding an at least partially enclosed volume from electromagnetic inference, and a method for using such enclosures, are described. The enclosure may comprise a continuous, non-planar piece of carbon foam. The continuous, non-planar piece of carbon foam may comprise at least two walls an angle greater than zero degrees and define at least a partially enclosed volume. Alternatively, the enclosure may include at least one curved wall and define at least a partially enclosed volume. The carbon foam of the enclosure is electrically conductive. The invention may also include a method for producing a carbon foam electromagnetic interference shielding enclosure. The method may comprise providing a continuous, non-planar carbonizable polymeric foam enclosure, heating the carbonizable polymeric foam enclosure to an first elevated temperature to provide a carbon foam enclosure, and heating the carbon foam enclosure to a maximum elevated temperature to provide carbon foam having an electrical resistivity of less than about 1 ohm-cm.

### BRIEF SUMMARY OF THE INVENTION

Enclosures for at least partially or mostly shielding an enclosed or partially enclosed volume from electromagnetic inference are provided. Certain embodiments of the invention provide an enclosure for at least partially shielding an enclosed or partially enclosed volume from electromagnetic interference. The enclosure may comprise a continuous, non-planar piece of carbon foam. The continuous, non-planar piece of carbon foam may comprise at least two walls an angle greater than zero and define at least a partially enclosed volume. In other embodiments, the continuous, non-planar piece of carbon foam may comprise at least one curved wall and define at least a partially enclosed volume. The carbon foam of the enclosure is electrically conductive.

The invention may also include a method for producing a carbon foam electromagnetic interference shielding enclosure. The method may comprise providing a continuous, non-planar carbonizable polymeric foam enclosure, heating the carbonizable polymeric foam enclosure to an first elevated temperature to provide a carbon foam enclosure, and heating the carbon foam enclosure to a maximum elevated temperature to provide carbon foam having an electrical resistivity of less than about 1 ohm-cm.

### BRIEF DESCRIPTION OF THE DRAWINGS

FIG. 1 is an illustration of an enclosure in accordance with an embodiment of the invention.

FIG. 2 is an illustration of an enclosure in accordance with another embodiment of the invention.

FIG. 3 is an illustration of an enclosure in accordance with yet another embodiment of the invention.

FIG. 4 is an illustration of an enclosure in accordance with still another embodiment of the invention.

FIG. 5 is an illustration of an enclosure in accordance with a further embodiment of the invention.

### DETAILED DESCRIPTION OF EMBODIMENTS OF THE INVENTION

Electrically conductive carbon foams are effective in blocking high frequency electromagnetic interference (EMI), including electromagnetic radiation in general, such as that generated by microwave emitters, including radar sources. In certain embodiments, the electrically conductive carbon foam may have an electrical resistivity of minimally less than 1 ohm-cm. In other embodiments, the electrically conductive carbon foam has an electrical resistivity of minimally less than 0.1 ohm-cm. Generally, lower resistivities are advantageous. As such, these electrically conductive carbon foams may be used to form enclosures, or shelters, having enclosed or partially enclosed volumes which are shielded from such EMI. The enclosed or partially enclosed volumes of these enclosures provide areas, for example, in which personnel and/or electronic equipment may be sheltered and function without the negative effects that may result from exposure to such interference.

Carbon foam comprising the EMI-contacting enclosure walls may be arranged such that the carbon foam provides for a continuous surface within or over those walls. Breaks, separations, cracks, or the like in this continuous electrically conductive carbon foam surface may significantly degrade the shielding effectiveness of the enclosure.

In certain embodiments, an EMI shielding enclosure may comprise a single, continuous, non-planar piece of carbon foam shaped to form an enclosure. Such enclosures may minimize the number of, or possibly eliminate, adhesive bonds between neighboring carbon foam sheets which may result in loss of EMI shielding effectiveness. Such minimization or elimination is provided by the walls of the enclosures of the present invention comprising one continuous piece of carbon foam. This is in contrast to previous carbon foam EMI shielding enclosures wherein the walls were comprised of two or more pieces of carbon foam bonded together with a conductive adhesive.

In some embodiments, an enclosure is provided that is capable of at least partially shielding a volume, typically an enclosed or partially enclosed volume of said enclosure, from electromagnetic interference (EMI). An at least partially enclosed volume is that space, area or volume near an enclosure that is at least partially shielded from EMI when the enclosure is located between a source of EMI and an object to be shielded. In some embodiments, an at least partially enclosed volume may be defined by a non-planar configuration of carbon foam. Non-planar configurations may include, but are not limited to, one or more curved walls of carbon foam or two or more planar carbon foam walls that intersect at an angle greater than zero degrees. As a result, personnel, electronic equipment, and/or items and materials, which may be collectively referred to as objects, located within the at least partially enclosed volume of the enclosure are then at least partially shielded from EMI. That electromagnetic interference may be in the range of about 400 MHZ to about 18 GHZ. At least partially shielded from EMI includes a reduction in EMI exposure to the partially enclosed volume when the enclosure is exposed to EMI. In certain embodiments, the reduction in EMI may be a partial reduction or an essentially complete reduction. In some embodiments the reduction in EMI may range from about 1% to about 100%. In other embodiments the reduction in EMI may range from about 10% to about 80%. In still other embodiment the reduction in EMI may range from about 99% to about 100%. In certain embodiments, the electrically conductive carbon foam may have an electrical resistivity of minimally less than 1 ohm-cm. In other embodiments, the electrically conductive carbon foam has an electrical resistivity of minimally less than 0.1 ohm-cm. In some embodiments, the carbon foam may exhibit compressive strengths ranging from about 50 p.s.i. to about 12,000 p.s.i, or greater. In further, embodiments, the carbon foam may exhibit a density ranging from about 0.05 g/cc to about 1.5 g/cc.

The EMI shielding enclosure may have one or more walls which at least partially enclose or otherwise define at least a partially enclosed volume. The thickness of the wall(s) of the enclosure is typically small as compared to the wall length and width. The enclosure minimally has two walls, where each wall defines a plane, wherein the defined planes intersect at an angle of greater than zero degrees. Alternatively, the enclosure may include at least one curved wall. The surface of the curved wall may define, for example, an arc, a circle, a polygon, an ellipse, a parabola, portions thereof, or the like, in a plane perpendicular to that wall. The wall(s) of the enclosure, which may be referred to as a carbon foam enclosure, comprises one continuous piece of electrically conductive carbon foam. That is, the carbon foam comprising the wall(s) of the enclosure is not comprised of smaller pieces of carbon foam bonded together. The carbon foam is essentially the same size as the wall(s) and is continuous, including those areas of interconnection, through those wall(s).

The carbon foam comprising the walls of the carbon foam enclosure may be surfaced coated, covered, or faced with other materials. These other materials may extend from the walls of the carbon foam enclosure in a manner coplanar with those walls. Alternatively, such other materials may extend form the carbon foam walls in a noncoplanar manner. Such other materials may provide, for example, additional wall strength, bracing at wall intersections, waterproofing, weather shielding, impact resistance, and the like. Such other materials may comprise, but are not limited to, carbon foam, fiberglass, thermosetting polymers, thermoplastic polymers, ceramics, paint, polymer composites, carbon composites, wood, paper, metals, metal composites, and the like. Such other materials may be applied, for example, by dipping, spraying (including thermal spraying), lay-up methods, painting, mechanical fasteners, deposition (including chemical vapor deposition and vacuum deposition), and the like.

The carbon foam comprising the walls of the enclosure may also be at least partially impregnated with thermosetting or thermoplastic polymers, resins, ceramics, metals, and the like. Interior or exterior supports may be affixed to the wall(s) of the enclosure. Such supports may be comprised of any solid material having sufficient strength to provide additional support to the carbon foam of the wall. Such solid materials may comprise, but are not limited to, solid polymers, wood, composites, metals, carbon foam, and the like. Carbon foam supports may be continuous with the carbon foam of the wall. Additional walls comprising carbon foam may be attached to the continuous carbon foam walls of the carbon foam enclosure using conventional methods. Such additional walls may provide the enclosed volume of the carbon foam enclosure with, for example, weather protection, thermal shielding, impact protection, and to some degree, EMI shielding that may supplement the shielding effectiveness of the enclosure.

The carbon foam may be prepared from a carbonizable polymeric foam. Carbonizable polymeric foams are polymeric foams that carbonize, when exposed to sufficiently high temperatures, to produce carbon foams. The carbon foams resulting from such carbonization essentially retain the same shape and cell structure as was exhibited by the polymeric foam prior to carbonization, although some shrinkage usually does occur. Suitable carbonizable polymeric foams may be produced from or comprise various carbonizable synthetic polymeric materials. Such carbonizable synthetic polymeric materials my comprise phenolic resins, furan resins, or resorcinol resins. Other types of suitable carbonizable synthetic polymeric materials that may be used to produce a carbonizable polymeric foam may include, but are not limited to, those comprising vinylidene chloride, furfuryl alcohol, polyacrylonitrile, polyurethane, combinations thereof, and the like. In some embodiments, a suitable carbonizable polymeric foam may include, but is not limited to, those foams commonly referred to as phenolic foams.

In an embodiment of the present invention, a carbonizable polymeric foam may be cast or otherwise formed (i.e. foamed from the resin), using conventional methods, in a mold. Typically, the mold interior will have approximately the shape and size of the desired carbon foam enclosure such that a single piece of carbonizable polymeric foam is produced therein having that mold interior size and shape. Alternatively, the mold may be designed to produce a volume of the carbonizable polymeric foam. Extraneous portions of the polymeric foam volume may then be removed by cutting, machining, or the like, to result in a single piece of sized and shaped carbonizable polymeric foam having approximately the shape and size of the desired carbon foam enclosure. For either method, as desired, the resulting single piece of carbonizable polymeric foam may be further shaped using conventional cutting and/or machining methods. In some embodiments, the resulting piece of carbonizable polymeric foam comprises an enclosure having the previously described carbon foam EMI shielding enclosure characteristics.

Generally, the sized and shaped carbonizable polymeric foam enclosure is produced somewhat oversize (i.e. larger) with respect to the desired final dimensions of the carbon foam EMI shielding enclosure. Such oversize production is desirable as the polymeric foam will typically shrink in all three dimensions when subsequently carbonized during conversion of the carbonizable polymeric foam to carbon foam. The degree of this shrinkage is typically dependent on the specific formulation of the carbonizable resin and to the temperatures to which the foam is exposed to during conversion to carbon foam. The degree of this shrinkage may be readily determined by methods known to those skilled in the associated arts. The mold used to form the carbon foam may be so designed and constructed that the foam produced therein exhibits multiple enclosed volumes, thicker or thinner areas or volumes, surface ridges or groves in the surface of the polymeric foam, designs on the surface of the foam, and the like.

Once it is of the desired size and shape, the formed polymeric foam enclosure is heated to elevated temperatures, by use of known methods, to progressively carbonize the polymeric foam to produce the carbon foam of the enclosure of the present invention. If the dimensions of the as-produced carbon foam are not within the tolerances desired or required for the enclosure walls, the carbon foam may be machined to the desired dimensions. Machining may be accomplished by use of conventional methods. Carbide tooling is typically recommended for such machining.

In certain embodiments, the heating of the foam to effect carbonization is conducted such that defects like cracking, warping, and/or possible breakage of the resultant carbon foam do not significantly occur. In some embodiments, such defects may be the result of the development of significant thermal gradients in the foam. Such significant thermal gradients may lead to non-uniform shrinkage of the foam with increasing temperature and are to be minimized, if not avoided. In some embodiments, heating of the polymeric foam or the resultant carbon foam is conducted in a non-reactive, oxygen free, essentially inert atmosphere. Likewise, cooling of the foam from elevated temperatures may be conducted in a non-reactive, oxygen free, essentially inert atmosphere until the carbon foam temperature is minimally less than about 400° C., and in some embodiments, less than about 150° C.

Heating of the polymeric foam enclosure or the resultant carbon foam enclosure to a maximum desired elevated temperature may be conducted in a continuous manner. Alternatively, such heating may be conducted as a series of steps performed in one or more pieces of heating equipment. For example, the polymeric foam may be carbonized in one furnace and the resulting carbon foam further carbonized in a second type of furnace, and exposed to graphitization temperatures in a third type of furnace. As an alternative example, the polymer foam may be carbonized, and further heated, even to graphitization temperatures, in a single furnace.

As discussed herein, carbonization of the foam may be considered to initiate at temperatures greater than room temperature and less than about 700° C. For some carbonizable polymeric foams, carbonization may initiate at a temperature of from about 250° C. to about 700° C. Carbonization may be further conducted at temperatures greater than about 700° C., even to temperatures as great as about 3200° C. or more. Graphitization temperatures are a subset of the range of carbonization temperatures and are usually considered to extend from about 1700° C., up to about 3200° C. or higher. Typically, the strength and electrical conductivity of carbon foam increase with respect to the maximum temperature to which the foam has been exposed, typically during preparation. For the purposes of the present invention, it is generally advisable to heat the foam to a temperature sufficiently high to result in the foam having an electrical resistivity of less than 1 ohm-cm. In other embodiments, it is generally advisable to heat the foam to a temperature sufficiently high to result in the foam having an electrical resistivity of less than 0.1 ohm-cm. For some foams, such a temperature may be minimally about 900° C. Heating the foam to temperatures greater than about 1000° C. may be advantageous as the foam strength and electrical conductivity typically increase with increasing carbonization temperature. If desired, the resultant carbon foam may be heated to temperatures as great as 3200° C. or more.

Once formed, the resultant continuous electrically conductive carbon foam comprises the walls of the enclosure of the present invention. The use of continuous carbon foam in the wall(s) of the enclosures of the present invention provides these enclosures with differentiated beneficial properties, such as the elimination of joining lines, which may make such enclosures particularly suitable as electromagnetic interference shielding enclosures.

The enclosures of the present invention may be used to shield the at least partially enclosed volume from electromagnetic interference by positioning the wall(s) of the enclosure between the source of the electromagnetic interference and the enclosed volume. In certain embodiments, the wall(s) of the enclosure are so positioned or otherwise orientated to maximize the shielding of the enclosed volume as provided by the enclosure walls. Objects placed, or otherwise located, in the at least partially enclosed volume of a carbon foam enclosure may also be shielded from EMI. Objects placed, or otherwise located, may include equipment, instruments, personnel, electronic devices, and the like.

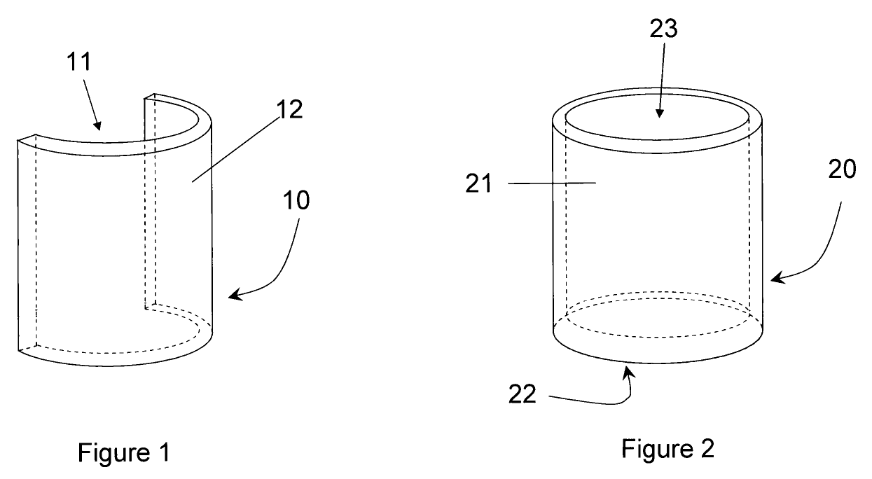

With reference now to FIG. 1, there is illustrated a carbonizable polymeric foam enclosure 10 having at least one curved wall in accordance with an embodiment of the invention. The enclosure 10 provides a partially enclosed volume in area 11 partially bounded by a curved polymeric foam wall 12. The resulting carbonizable polymeric foam enclosure may be then heated to a temperature sufficient to carbonize the carbonizable polymeric foam and result in the carbon foam exhibiting an electrical resistivity of less than 0.1 ohm-cm. For some carbon foams the temperature may be minimally at least about 900° C. As desired, the foam may be heated to even higher temperatures. Following heating, the resultant carbon foam enclosure is cooled. Heating of the polymeric foam enclosure or the resultant carbon foam enclosure may be conducted in a non-reactive, oxygen free, essentially inert atmosphere. Likewise, cooling of the carbon foam enclosure may be conducted in a non-reactive, oxygen free, essentially inert atmosphere until the carbon foam temperature is minimally less than about 400° C. and, in some embodiments, less than about 150° C.

The resultant carbon foam enclosure may be slightly smaller than the size of the carbonizable polymeric foam enclosure as a result of the possible shrinkage due to the carbonization process. The resultant carbon foam enclosure otherwise exhibits essentially the same shape and cell structure as the carbonizable polymeric foam enclosure. Therefore, the carbon foam provides for an enclosure having wall(s) comprised of a single continuous piece of carbon foam. In this particular embodiment, the enclosure has one wall, curved in at least one plane intersecting that wall, which at least partially encloses or otherwise defines at least a partially enclosed volume. The surface of the curved carbon foam wall defines a partial ellipse in that plane. The surface of such a carbon foam enclosure may be coated, covered, or faced with any of a number of materials as discussed above. The carbon foam may be impregnated as discussed above. Supports of other material(s) may be attached to the wall.

Such a carbon foam enclosure may be used to shield objects in the enclosed volume from EMI. Such shielding is provided by positioning, or otherwise locating, said objects in the at least partially enclosed volume defined by the enclosure wall and placing the wall between said objects and the source of the EMI.

With reference now to FIG. 2, there is shown a hollow carbonizable polymeric foam cylindrical enclosure 20 in accordance with an embodiment of the invention. The shape of the enclosure may be machined from a suitably sized section of carbonizable polymeric foam. Alternatively, the enclosure may be cast or otherwise formed in a suitably shaped mold. In this illustration, only one end of the cylinder is open. The opposite end is closed with polymeric foam that is continuous with that of the cylinder wall. The cylindrical enclosure 20 exhibits a cylinder wall 21 and closed end 22 which at least partially define a partially enclosed volume 23. The resulting polymeric foam closed end cylinder may be heated to elevated temperatures to convert the polymeric foam to carbon foam having the desired electrical resistivity as was detailed in the first illustration. The resulting carbon foam may be cooled as discussed above.

The resultant carbon foam closed end cylinder is smaller than the polymeric foam closed end cylinder but exhibits essentially the same shape and cell structure. Therefore, the carbon foam provides for an enclosure having walls comprising carbon foam. In this case the enclosure has two walls which at least partially enclose or otherwise define at least a partially enclosed volume. One wall of the enclosure is curved in at least one plane intersecting that wall. The surface of the curved carbon foam wall defines a circle in that plane. The other wall is parallel to that intersecting plane. The carbon foam is one piece and continuous through all walls. The surface of such a carbon foam enclosure may be coated, covered, or faced with any of a number of materials as discussed above. Additionally, the carbon foam may be impregnated as discussed above. Supports of other material(s) may be attached to the wall.

Such a carbon foam enclosure may be used to shield objects in the enclosed volume from EMI. If the major dimensions of the carbon foam cylinder are on the order of inches, such a closed end carbon foam cylinder may be used, for example, to shield electronic components from EMI. If the major dimensions of the carbon foam enclosure are on the order of feet, such an enclosure may be used, for example, to shield small scale equipment from EMI. If the major dimensions of the carbon foam enclosure are on the order of multiple feet, such an enclosure may be used, for example, to shield personnel and/or large scale equipment from EMI.

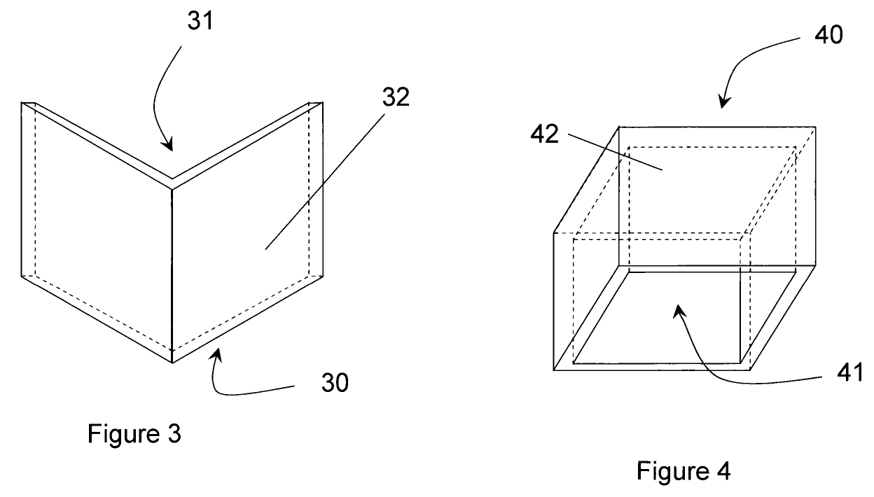

Another embodiment of an enclosure is illustrated in FIG. 3. A carbonizable polymeric foam enclosure 30 provides a partially enclosed volume in area 31 partially bounded by polymeric foam walls 32. The carbonizable polymeric foam enclosure is thermally treated, and the resultant carbon foam enclosure cooled, as discussed above.

The resultant carbon foam enclosure is smaller than the cast polymeric foam enclosure but exhibits essentially the same shape and cell structure. Therefore, the carbon foam provides for an enclosure having walls comprising carbon foam. In this case the carbon foam enclosure has two planer walls, interconnected at a wall edge, each comprised of carbon foam, wherein the length and width of each define intersecting planes which enclose or otherwise define at least a partially enclosed volume. The carbon foam is one piece and continuous through both walls. The surface of such a carbon foam enclosure may be coated, covered, or faced with any of a number of materials as discussed above. The carbon foam may be impregnated as discussed above. Supports of other material(s) may be attached to the wall. The utility of such a carbon foam enclosure may be, but is not limited to, any of those discussed above.

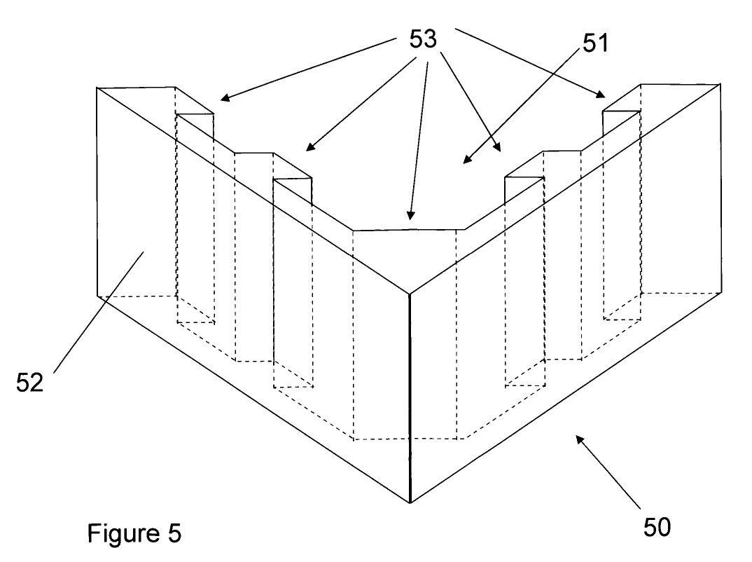

With reference now to FIG. 4, there is illustrated another enclosure 40 in accordance with an embodiment of the invention. The enclosure 40 provides a partially enclosed volume in area 41 partially bounded by polymeric foam walls 42. The carbonizable polymeric foam enclosure is thermally treated, and the resultant carbon foam enclosure cooled, as discussed above.

The resultant carbon foam enclosure is smaller than the cast polymeric foam enclosure but exhibits essentially the same shape and cell structure. Therefore, the carbon foam provides for an enclosure having walls comprising carbon foam. In this case the carbon foam enclosure has five planer walls, interconnected at wall edges, each comprised of carbon foam, wherein the length and width of each define intersecting planes which enclose or otherwise define at least a partially enclosed volume. The carbon foam is one piece and continuous through all walls. The surface of such a carbon foam enclosure may be coated, covered, or faced with any of a number of materials as discussed above. The carbon foam may be impregnated as discussed above. Supports of other material(s) may be attached to the wall. The utility of such a carbon foam enclosure may be, but are not limited to, any of those discussed above.

Turning to FIG. 5, there is illustrated an enclosure 50 in accordance with certain embodiments of the invention. The enclosure 50 provides a partially enclosed volume in area 51 partially bounded by polymeric foam walls 52. In this illustration, polymeric foam wall supports 53 are continuous with the polymeric foam of the wall. Provision for such polymeric foam wall supports are made in the mold used to cast the polymeric foam enclosure. The carbonizable polymeric foam enclosure is thermally treated, and the resultant carbon foam enclosure cooled, as discussed above.

The resultant carbon foam enclosure is smaller than the cast polymeric foam enclosure but exhibits essentially the same shape and cell structure. Therefore, the carbon foam provides for an enclosure having walls comprising carbon foam. In this case the carbon foam enclosure has two planer walls, interconnected at a wall edge and each comprised of carbon foam, wherein the length and width of each define intersecting planes which enclose or otherwise define at least a partially enclosed volume. The carbon foam is one piece and continuous through all walls. The carbon foam walls are additionally supported by carbon foam wall supports. The carbon foam of these wall supports is continuous with the carbon foam of the wall. The surface of such a carbon foam enclosure may be coated, covered, or faced with any of a number of materials as discussed above. The carbon foam may be impregnated as discussed above. Supports of other material(s) may be attached to the wall. The utility of such a carbon foam enclosure may be, but are not limited to, any of those discussed above.

Having discussed several embodiment of the invention above in detail, the invention has broad applicability and is only limited by the scope of the appended claims.

What is claimed is:

1. An enclosure for at least partially shielding an at least partially enclosed volume from electromagnetic interference, the enclosure comprising:
a continuous non-planar piece of electrically conductive carbon foam defining an at least partially enclosed volume.

2. The enclosure of claim 1, wherein said continuous piece of carbon foam comprises at least two walls at an angle greater than zero.

3. The enclosure of claim 1, wherein said continuous piece of carbon foam comprises a wall curved in at least one plane.

4. The enclosure of claim 1, wherein said electrically conductive carbon foam has an electrical resistivity less than about 1 ohm-cm.

5. The enclosure of claim 1, wherein said electrically conductive carbon foam has an electrical resistivity less than about 0.1 ohm-cm.

6. The enclosure of claim 1, wherein at least one surface of said continuous piece of carbon foam comprises a coated surface.

7. The enclosure of claim 6, wherein said coated surface is selected from the group consisting of carbon foam, fiberglass, thermosetting polymers, thermoplastic polymers, ceramics, paint, polymer composites, carbon composites, wood, paper, metals, and metal composites.

8. The enclosure of claim 6, wherein said coated surface comprises at least partial impregnation of an impregnating material selected from the group consisting of thermosetting polymers, thermoplastic polymers, resins, carbon, ceramics, and metals.

9. The enclosure of claim 1, further comprising a support member affixed to said continuous piece of carbon foam.

10. The enclosure of claim 9, wherein said support member is comprised of a support material selected from the group consisting of solid polymers, wood, composites, metals, and carbon foam.

11. The enclosure of claim 1, wherein said continuous piece of carbon foam has a compressive strength ranging from about 50 psi to about 12,000 psi.

12. The enclosure of claim 1, wherein said continuous piece of carbon foam has a density ranging from about 0.05 g/cc to about 1.5 g/cc.

13. A method for producing a carbon foam electromagnetic interference shielding enclosure comprising:
providing a continuous, non-planar carbonizable polymeric foam enclosure;
heating the carbonizable polymeric foam enclosure to a first elevated temperature to provide a carbon foam enclosure; and
heating the carbon foam enclosure to a maximum elevated temperature to provide carbon foam having an electrical resistivity of less than about 1 ohm-cm.

14. The method of claim 13, wherein said carbonizable polymeric foam enclosure comprises a continuous piece of carbon foam comprising at least two walls at an angle greater than zero degrees and defining at least a partially enclosed volume.

15. The method of claim 13, wherein said carbonizable polymeric foam enclosure comprises a continuous piece of carbon foam comprising a curved wall and defines at least a partially enclosed volume.

16. The method of claim 13, further comprising the step of forming said carbonizable polymeric foam enclosure in a mold.

17. The method of claim 13, further comprising the steps of providing a carbonizable polymeric foam body and shaping said carbonizable polymeric foam body to provide a carbonizable polymeric foam enclosure.

18. The method of claim 13, wherein said first elevated temperature is greater than about 700° C.

19. The method of claim 13, wherein said maximum elevated temperature is greater than about 900° C.

20. The method of claim 13, wherein said heating is conducted in a non-reactive, oxygen free, essentially inert atmosphere.

21. The method of claim 13, further comprising the step of cooling said carbon foam enclosure from said maximum elevated temperature to a temperature less than about 400° C. in a non-reactive, oxygen free, essentially inert atmosphere.

22. The method of claim 13, further comprising the step of cooling said carbon foam enclosure from said maximum elevated temperature to a temperature less than about 150° C. in a non-reactive, oxygen free, essentially inert atmosphere.

23. The method of claim 13, further comprising the step of producing said carbonizable polymeric foam enclosure from a carbonizable synthetic polymeric foam material.

24. The method of claim 23, wherein said carbonizable synthetic polymeric foam material is selected from the group consisting of furan resin, resorcinol resin, vinylidene chloride, furfuryl alcohol, polyacrylonitrile, polyurethane, and combinations thereof.

25. The method of claim 23, wherein said carbonizable synthetic polymeric foam material comprises phenolic resin.

26. The method of claim 13, wherein said carbonizable polymeric foam enclosure comprises phenolic foam.

27. A method for at least partially shielding an object from electromagnetic interference, comprising the steps of:
positioning a continuous, non-planar piece of carbon foam defining an at least partially enclosed volume between a source of electromagnetic interference and an object, wherein said carbon foam is electrically conductive;
orientating said enclosure such that said at least partially enclosed volume is at least partially shielded from electromagnetic interference, and said object is located in said at least partially enclosed volume.

28. The method of claim 27, wherein said continuous piece of carbon foam comprises at least two walls at an angle greater than zero.

29. The method of claim 27, wherein said continuous piece of carbon foam comprises a wall curved in at least one plane.
